(19) United States
(12) Patent Application Publication
(10) Pub. No.: US 2017/0055731 A1
(43) Pub. Date: Mar. 2, 2017

(54) Mirror Mount

(71) Applicant: Raytheon Company, Waltham, MA (US)

(72) Inventors: Andrew L. Bullard, Manhattan Beach, CA (US); Hans P. Naepflin, El Segundo, CA (US)

(73) Assignee: Raytheon Company

(21) Appl. No.: 14/836,672

(22) Filed: Aug. 26, 2015

(51) Int. Cl. A47G 1/17; C09J 5/00

(52) U.S. Cl. CPC A47G 1/17; C09J 5/00

(57) ABSTRACT

A mirror mount system is disclosed. The mirror mount system can include a rib forming a support structure of a mirror. The rib can have an attachment portion. The mirror mount system can also include an attachment fitting bonded to the attachment portion of the rib with an adhesive. The attachment portion can be sufficiently isolated from other portions of the rib structure such that loading in the other portions of the rib structure tending to distort the mirror, which is generated internal to the attachment fitting and the attachment portion, is minimized while providing adequate structural support for the mirror.

### BACKGROUND

When attaching large mirrors (i.e., greater than ˜0.5 meter diameter) to a mounting or external support structure, the goal is to do so in a way that does not disturb the “figure” or shape of the optical surface of the mirror. Surface distortion of a mirror's optical surface, or “figure error,” is typically held to very tight tolerances (e.g., a fraction of a millionth of an inch). The larger the mirror the more difficult it is to avoid distortion and meet the tolerance requirements. Adhesive is typically used to attach the mirror to an external support structure because other ways (e.g., fasteners) result in excessive distortion of the mirror. In some cases, a large mirror will have a relatively large mass of material at a mount location to reduce stress at the mount location, and therefore reduce distortion of the optical surface. A metal fitting is bonded or screwed to the mirror at this location for attachment to an external support structure. Another approach is to bond a metal insert into a cylindrical hole in the mirror, often at an intersection of support ribs on a back side of the mirror.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an illustration of a mirror mount system in accordance with an example of the present disclosure.

FIG. 2 is detail cross-sectional view of attachment features of the mirror mount system of FIG. 1 in accordance with an example of the present disclosure.

FIG. 3 is a detail cross-sectional view of an attachment fitting bonded to a rib in accordance with an example of the present disclosure.

FIG. 4 illustrates a rib attachment feature of FIG. 2 showing a bond spot on an attachment portion of the rib.

FIG. 5 is detail cross-sectional view of attachment features of the mirror mount system of FIG. 1 in accordance with another example of the present disclosure.

FIG. 6 is a detail cross-sectional view of an attachment fitting bonded to a rib in accordance with another example of the present disclosure.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although providing a relatively large mass of material at a mount location may effectively support a mirror with acceptable levels of distortion, this approach is not lightweight and may not be feasible for some applications, such as for mirrors that must be launched into space. While a metal insert bonded in a hole may not introduce weight concerns, this approach can result in unacceptable figure error due to the shrinkage of the adhesive in the hole as the adhesive cures, which can “print through” a deformation to the mirror's optical surface causing distortion that can exceed tolerances. In addition, a coefficient of thermal expansion (CTE) differential between any of the metal insert, the adhesive, and the mirror substrate can also cause figure error, which can be exacerbated when the temperature decreases as the mirror is transported to space. Furthermore, large lightweight mirrors often have a lot of weight concentrated at the mirror mount locations because the load transfer between the external support structure and the mirror is not structurally efficient and/or because adding material to the mirror substrate reduces the thermo-elastically induced figure error caused by the metal insert, adhesive, and the mirror substrate CTE differential. Thus, mounting of large, lightweight mirrors can be improved by reducing print through to the optical surface due to curing of the adhesive and by being thermally tolerant while not increasing weight.

Accordingly, a mirror mount system is disclosed that can limit print through to the optical surface due to curing of the adhesive to acceptable levels while being able to accommodate temperature changes without excessive distortion of the optical surface in a manner that does not increase weight. The mirror mount system can include a rib forming a support structure of a mirror, the rib having an attachment portion. The mirror mount system can also include an attachment fitting bonded to the attachment portion of the rib with an adhesive. The attachment portion can be sufficiently isolated from other portions of the rib structure such that loading in the other portions of the rib structure tending to distort the mirror, which is generated internal to the attachment fitting and the attachment portion, is minimized while providing adequate structural support for the mirror.

A mirror support structure is also disclosed that can include a rib forming a portion of a support structure of a mirror. The rib can have an attachment portion to bond to an attachment fitting with an adhesive. The attachment portion can be sufficiently isolated from other portions of the rib structure such that loading in the other portions of the rib structure tending to distort the mirror, which is generated internal to the attachment fitting and the attachment portion, is minimized while providing adequate structural support for the mirror.

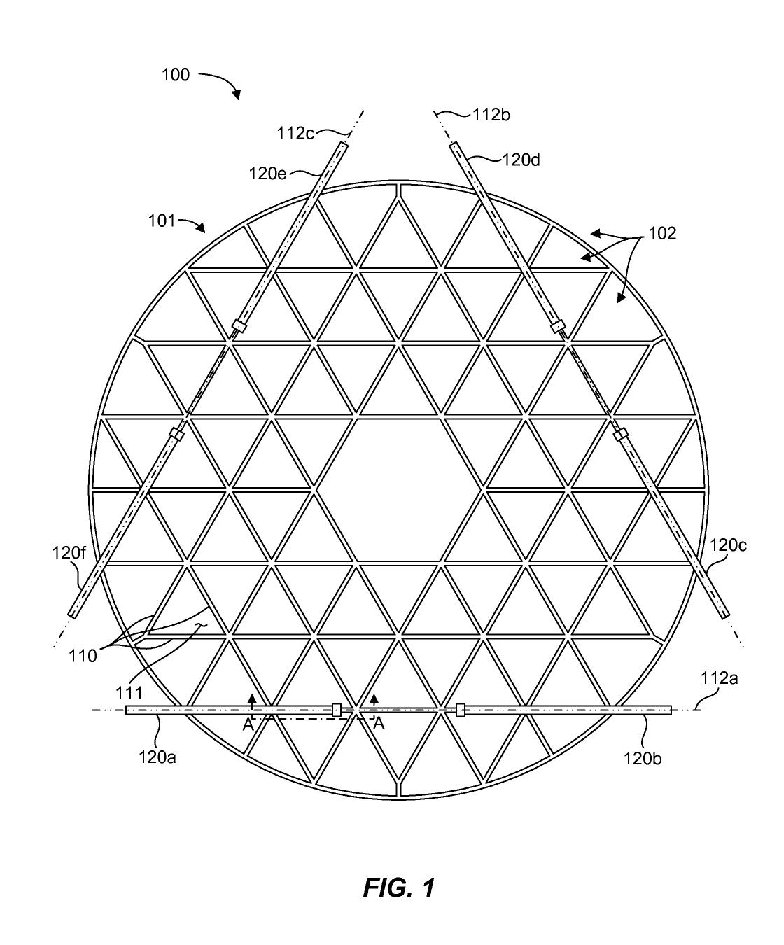

One example of a mirror mount system 100 is illustrated in FIG. 1. The mirror mount system 100 illustrated in the figure is viewed from a back side of a mirror 101, such that a support structure 102 of the mirror 101 is visible. The mirror optical surface is hidden from view in the figure. The support structure 102 typically includes ribs 110 extending from a facesheet 111, which can form a substrate for the mirror's optical surface. The ribs 110 can be in any suitable arrangement or configuration to provide adequate structural support for the mirror 101. As illustrated in the figure, the ribs are arranged in a triangular isogrid pattern, which can provide a lightweight and stiff structure or substrate for the mirror's optical surface. Struts 120a-f can form part of an external support structure for the mirror 101 and can be coupled to the ribs 110 to mount the mirror 101 to base structure, such as a satellite, via strut mounts (not shown). As illustrated, the struts 120a-f can be aligned with the ribs 110 to which they are attached to efficiently transfer loads from the base structure to the mirror 101. In this case, six struts 120a-f are arranged in pairs, which are aligned with the ribs 110 or rib planes 112a-c oriented in three directions. As discussed in more detail below, the struts 120a-f can also be bonded or attached via an attachment fitting directly to the ribs 110 to which the struts are aligned. With the struts 120a-f in-line with the ribs 110 or rib planes 111a-c, out-of-plane loads can be minimized or prevented from being imparted onto the ribs 110. Such a configuration can achieve an extremely efficient load transfer path from the strut mounts into the mirror 101, thus eliminating the need for much of the extra weight in this area of the mirror support structure typically found in most mirror mounts.

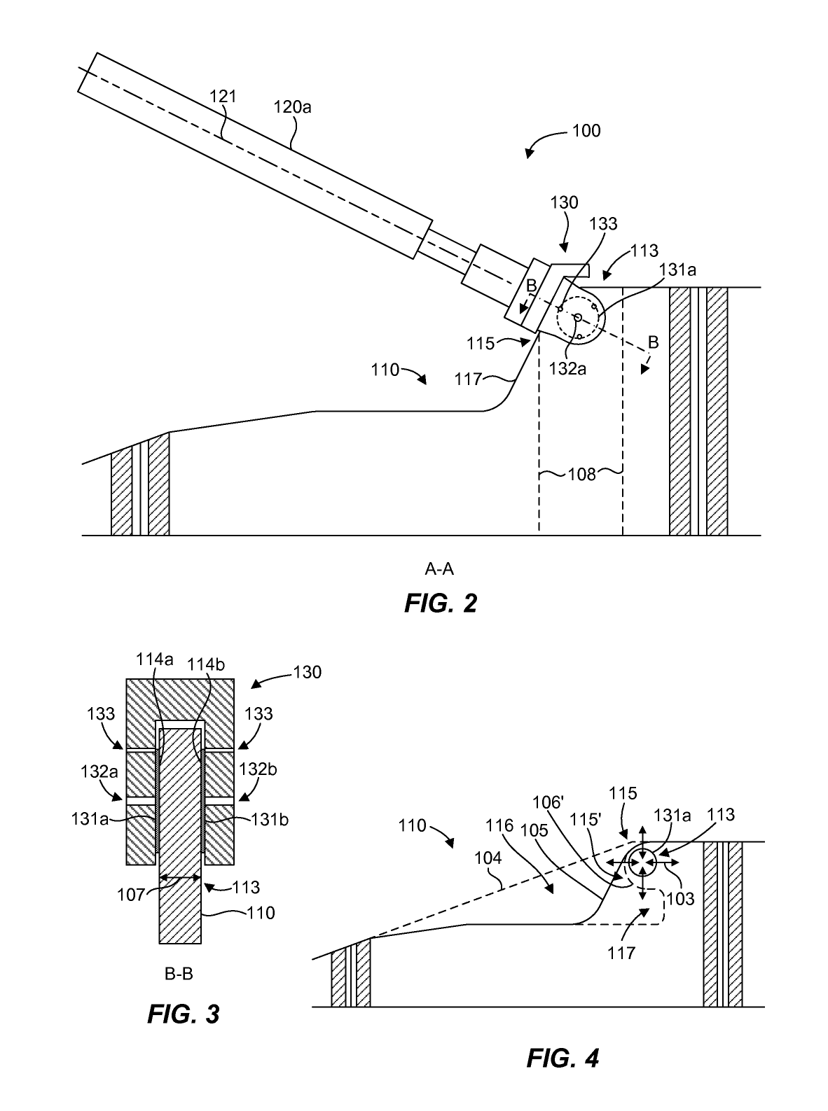

FIG. 2 illustrates a cross-section detailing the attachment features of the mirror mount system 100, in particular those features that facilitate attaching a strut to a rib. As shown in the figure, the rib 110 can include an attachment portion 113. An attachment fitting 130 can be bonded to the attachment portion of the rib 110 with an adhesive, which can be any suitable substance, such as a glue, cement, mucilage, paste, etc., which can be applied to surfaces of the attachment fitting 130 and/or the attachment portion 113 that can bind them together and resist separation.

As shown in the detailed cross-sectional view of FIG. 3, the attachment portion 113 can include an adhesive interface surface 114a, 114b to facilitate bonding the attachment fitting 130 to the attachment portion 113 of the rib 110. The adhesive interface surface 114a, 114b can be oriented parallel to a longitudinal axis 121 of the strut 120a, which is coupled to the attachment fitting 130. In one aspect, the attachment fitting 130 can comprise a bracket in a clevis configuration, as shown in FIGS. 2 and 3. Thus, two adhesive interface surfaces 114a, 114b can be located on opposite sides of the rib 110 to bond the attachment fitting 130 directly to opposite sides of the rib. In this case, two relatively small bond spots 131a, 131b (one on each side of the rib) can be used in place of a single relatively large bond spot to reduce the amount of print through compared to that of the single large bond spot. In general, the larger the bond spot area, the worse the print through. Two small bond spots with at least as much total area as the single large bond spot can be as strong as the single large bond spot. In addition, the bond spots 131a, 131b attaching the clevis attachment fitting 130 to the rib 110 subjects the bond primarily to shear loading, which may be a design preference compared to a configuration that subjects the bond primarily to tensile and compressive loading.

In one aspect, the attachment fitting 130 can include one or more adhesive injection ports 132a, 132b. The adhesive injection ports 132a, 132b can be configured to deposit adhesive on the adhesive interface surfaces 114a, 114b of the attachment portion 113. Typically, a circular-shaped injection bond spot will result, but other configurations are possible. The attachment fitting 130 can also include one or more witness holes 133 to view the progression of adhesive as it is injected to ensure that a sufficiently large bond spot is achieved. In one aspect, the attachment fitting 130 can be bonded to the rib 110 and then the strut 120a can be attached to the attachment fitting 130.

With continued reference to FIGS. 2 and 3, FIG. 4 illustrates the rib 110 of FIG. 2 with the strut and attachment fitting removed to show the bond spot 131a on the attachment portion 113. FIG. 4 illustrates loading (represented by arrows 103) generated internal to the attachment fitting 130 and the attachment portion 113. Such loading typically includes thermally induced stresses (e.g., CTE mismatch) and adhesive shrinkage, which can cause the attachment portion 113 to radially expand or contract resulting in loading in other portions of the rib structure that can tend to distort the optical surface of the mirror to an extent that unacceptable figure error results. For example, in a typical rib configuration (identified in profile by reference no. 104), as the bond expands or contracts it puts stress on the top of the rib and causes this portion of the rib to expand or contract, which causes bending that can distort the optical surface of the mirror. Thus, loading generated internal to the attachment fitting 130 and the attachment portion 113 can be transferred through the rib structure to other portions of the rib that are remote from the attachment fitting 130 and the attachment portion 113, which can tend to distort the mirror.

In contrast, the attachment portion 113 can be isolated from other portions of the rib structure, such as by being located on a “lobe” of the rib 110, which can be defined, at least in part, by a protrusion 115 of the rib 110 having a profile identified by reference no. 105. As illustrated in FIG. 4, the rib 110 can “step down” forming a “notch” 116 on one side of the attachment portion 113 to isolate the bond spot 131a on the lobe or protrusion 115 to prevent global bending of the mirror that would be created due to bond shrinkage and/or CTE mismatch. If the rib profile followed the typical continuous slope as in profile 104, then radial expansion of attachment portion 113 of the rib 110 would result in much greater figure error. Thus, the attachment portion 113 can be sufficiently isolated from other portions of the rib structure such that loading originating in the lobe or protrusion 115 that would otherwise create loading in other portions of the rib structure tending to distort the mirror is minimized or reduced, thus minimizing or reducing mirror distortion. In other words, the attachment portion 113 can be located at a lobe that protrudes from the surrounding rib structure such that relative growth or shrinkage between the bonded portion of the rib 110 and the surrounding rib structure does not cause global bending of the mirror. For example, a load path for loading generated internal to the attachment fitting 130 and the attachment portion 113 (e.g., originating from the arrows 103) can be isolated to the attachment portion 113 sufficient to minimize loading in the other portions of the rib structure tending to distort the mirror. Isolating the attachment portion 113, such as by putting the notch 116 on one side of the bond spot or attachment portion 113, can effectively break the load path through the rib 110. As a result, contraction or expansion of the attachment portion 113 of the rib 110 is confined locally to the attachment portion 113 such that there is no rib structure that can be pulled or pushed by the contraction or expansion of the attachment portion 113. With expansion and contraction of the attachment portion 113 effectively isolated to the attachment portion 113, print through to the rest of the mirror structure is minimized or eliminated.

A rib profile identified by reference no. 106 illustrates another example of a lobe or protrusion 115′ of a rib in which the lobe or protrusion 115′ is undercut 117 to even further isolate the attachment portion of the rib compared to the profile identified by reference no. 105. It should be recognized that a lobe or protrusion of a rib can be of any suitable configuration that isolates the attachment portion from other portions of the rib structure sufficient to adequately reduce loading tending to cause distortion of the mirror, while providing adequate structural support for the mirror. Typically, the degree of mirror distortion due to the stresses originating at the lobe or protrusion can be balanced against the structural support provided by the lobe, which serves as the attachment location for the strut and is subjected to loading (e.g., operating loads) from the strut. In other words, the amount of isolation of the attachment portion can be configured to provide adequate joint strength while minimizing or reducing distortion of the mirror due to bond shrinkage and/or CTE mismatch to acceptable tolerances. Thus, the attachment portion can be further isolated to reduce mirror distortion with a trade-off in joint strength.

In one aspect, illustrated in FIG. 2, the protrusion or lobe 115 can be configured to provide a surface 117 that is normal or perpendicular to the longitudinal axis 121 of the strut 120a, which can provide for convenience in bonding the attachment fitting 130 to the attachment portion 113. The protrusion 115 can therefore serve to provide low figure error by isolating the attachment portion 113 and facilitate attachment to the strut 120a such that the strut 120a is in-line with the rib 110 thus minimizing or preventing out-of-plane loads from being imparted onto the rib 110.

In one aspect, illustrated in FIGS. 2 and 3, a thickness 107 of the attachment portion 113 can be greater than a thickness of an adjacent portion of the rib. For example, the thickness 107 between broken lines 108 can be greater than a thickness outside the broken lines 108. Such thickened material can be thinned down away from the attachment portion 113 to a thickness needed to handle the loads transferred through the struts. A locally increased thickness in attachment portion 113 can reduce or minimize mirror distortion by resisting the shrinkage force of the adhesive.

In one aspect, the attachment fitting 130 and the rib 110 can have approximately the same coefficient of thermal expansion (CTE). For example, the rib 110 can be constructed of silicon carbide (SiC) and the attachment fitting 130 can be constructed of Invar® (a nickel-iron alloy known for having a low CTE), although any suitable material can be used for either component, such as aluminum for both the attachment fitting and the rib. In one aspect, the attachment fitting 130 can be designed to have flexion in the direction of rib thickness, which can further reduce the impact that differential CTE will have on figure.

Ribs are a typical feature of many mirror supports, so incorporating the principles disclosed herein should not add any extra weight to a mirror.

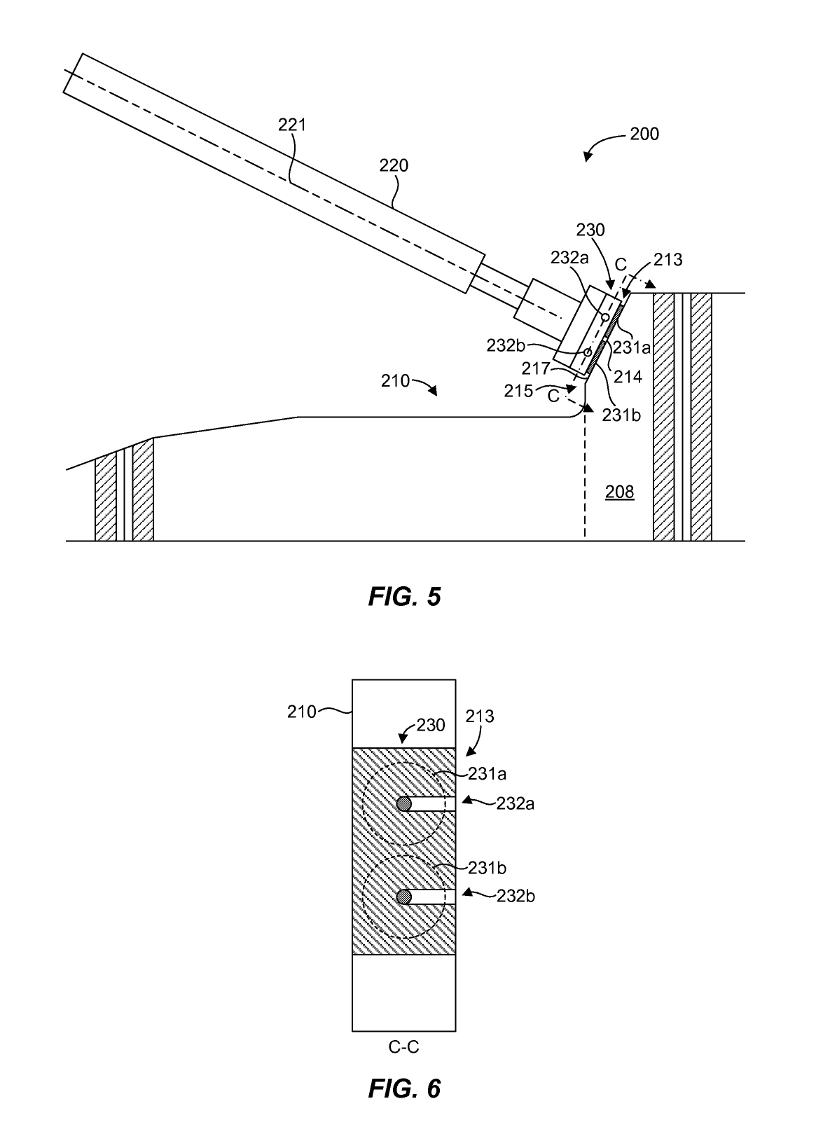

FIG. 5 illustrates a mirror mount system 200 in accordance with another example of the present disclosure. The system 200 is similar to the system 100 discussed above in many respects, such as having a rib 210 configured to include a protrusion or lobe 215 that isolates an attachment portion 213 for bonding to an attachment fitting 230. The protrusion or lobe 215 can also be configured to provide a surface 217 that is normal or perpendicular to a longitudinal axis 221 of a strut 220 that is attached to the attachment fitting 230. In this case, the attachment portion 213 can utilize the surface 217 normal or perpendicular to the strut longitudinal axis 221 for the location of the adhesive interface surface 214. Thus, instead of bonding to the sides of the rib, as in the system 100, the bond is normal to the rib face, which orients the bond joint normal to the strut vector, placing the bond in tension or compression under operating loads. Bond spots radially expand and contract as the temperature changes. Thus, a configuration orienting the bond joint normal to the strut vector can accommodate more stress than the system 100 configuration. The result is more strength with less figure error than in the system 100 configuration. The adhesive interface surface 214 can form a surface of a locally thickened portion 208 of the rib 210, which may be thickened to accommodate joint stresses as well as to provide a suitable bond surface area. Any number of bond spots of any suitable size can be used to fit adhesive onto the adhesive interface surface 214 so that the rib 210 does not become overly thick just to accommodate a desired bond surface area. Two bond spots 231a, 231b are shown by way of example in FIGS. 5 and 6. The bond spots 231a, 231b can be distributed in a manner that fits the shape of the available area of the adhesive interface surface 214 of the rib 210. Thus, the adhesive interface surface 214 can be configured to facilitate bonding the attachment fitting 230 to the attachment portion 213 with any number of bond spots needed to achieve a desired bond strength.

Typically, the bond spots 213a, 231b will be circular, as illustrated in FIG. 6, as adhesive is injected into adhesive injection ports 232a, 232b in the attachment fitting 230 and directed to the adhesive interface surface 214. The adhesive injection ports 232a, 232b can be configured to provide access to an adhesive source (not shown), such as on a side of the attachment fitting 230, and then routed toward the adhesive interface surface 214, which may require a 90 degree bend or turn. In one aspect, adhesive can be applied to the adhesive interface surface 214 in a “butter bond” before the attachment fitting 230 interfaces with the rib 210. Such a “butter bond” can be of any shape, not just circular, because the adhesive is not applied by injection through an adhesive injection port in the attachment fitting.

In accordance with one embodiment of the present invention, a method for facilitating mounting a mirror is disclosed. The method can comprise providing a rib that forms a support structure of a mirror, the rib having an attachment portion. The method can also comprise facilitating bonding of an attachment fitting to the attachment portion of the rib with an adhesive, wherein the attachment portion is sufficiently isolated from other portions of the rib structure such that loading in the other portions of the rib structure tending to distort the mirror, which is generated internal to the attachment fitting and the attachment portion, is minimized while providing adequate structural support for the mirror. It is noted that no specific order is required in this method, though generally in one embodiment, these method steps can be carried out sequentially.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A mirror mount system, comprising:
a rib forming a support structure of a mirror, the rib having an attachment portion; and
an attachment fitting bonded to the attachment portion of the rib with an adhesive,
wherein the attachment portion is sufficiently isolated from other portions of the rib structure, such that loading in the other portions of the rib structure tending to distort the mirror, which is generated internal to the attachment fitting and the attachment portion, is minimized while providing adequate structural support for the mirror.

2. The mirror mount system of claim 1, wherein a load path for loading generated internal to the attachment fitting and the attachment portion is isolated to the attachment portion sufficient to minimize loading in the other portions of the rib structure tending to distort the mirror.

3. The mirror mount system of claim 1, wherein the loading generated internal to the attachment fitting and the attachment portion is due to at least one of adhesive shrinkage and coefficient of thermal expansion mismatch.

4. The mirror mount system of claim 1, wherein the attachment portion is defined at least in part by a protrusion of the rib.

5. The mirror mount system of claim 1, wherein a thickness of the attachment portion is greater than a thickness of an adjacent portion of the rib.

6. The mirror mount system of claim 1, wherein the attachment portion comprises an adhesive interface surface to facilitate bonding the attachment fitting to the attachment portion.

7. The mirror mount system of claim 6, wherein the adhesive interface surface is oriented parallel to a longitudinal axis of a strut coupled to the attachment fitting.

8. The mirror mount system of claim 6, wherein the adhesive interface surface is oriented perpendicular to a longitudinal axis of a strut coupled to the attachment fitting.

9. The mirror mount system of claim 6, wherein the adhesive interface surface comprises two adhesive interface surfaces on opposite sides of the rib.

10. The mirror mount system of claim 6, wherein the adhesive interface surface is configured to facilitate bonding the attachment fitting to the attachment portion with a plurality of bond spots.

11. The mirror mount system of claim 1, wherein the attachment fitting comprises at least one adhesive injection port.

12. The mirror mount system of claim 11, wherein a plurality of adhesive injection ports are configured to deposit adhesive on an adhesive interface surface of the attachment portion.

13. The mirror mount system of claim 1, wherein the attachment fitting comprises a witness hole.

14. The mirror mount system of claim 1, wherein the attachment fitting comprises a clevis bracket.

15. A mirror support structure, comprising:
a rib forming a portion of a support structure of a mirror, the rib having an attachment portion to bond to an attachment fitting with an adhesive,
wherein the attachment portion is sufficiently isolated from other portions of the rib structure, such that loading in the other portions of the rib structure tending to distort the mirror, which is generated internal to the attachment fitting and the attachment portion, is minimized while providing adequate structural support for the mirror.

16. The mirror support structure of claim 15, wherein a load path for loading generated internal to the attachment fitting and the attachment portion is isolated to the attachment portion sufficient to minimize loading in the other portions of the rib structure tending to distort the mirror.

17. The mirror support structure of claim 15, wherein the attachment portion is defined at least in part by a protrusion of the rib.

18. The mirror support structure of claim 15, wherein a thickness of the attachment portion is greater than a thickness of an adjacent portion of the rib.

19. The mirror support structure of claim 15, wherein the attachment portion comprises an adhesive interface surface to facilitate bonding the attachment fitting to the attachment portion with a plurality of bond spots.

20. A method for facilitating mounting a mirror, comprising:
providing a rib that forms a support structure of a mirror, the rib having an attachment portion; and
facilitating bonding of an attachment fitting to the attachment portion of the rib with an adhesive,
wherein the attachment portion is sufficiently isolated from other portions of the rib structure, such that loading in the other portions of the rib structure tending to distort the mirror, which is generated internal to the attachment fitting and the attachment portion, is minimized while providing adequate structural support for the mirror.
